(19) United States
(12) Patent Application Publication
(10) Pub. No.: US 2018/0122003 A1
(43) Pub. Date: May 3, 2018

(54) CREDIT ADMINISTRATION MANAGEMENT SYSTEM AND METHOD THEREFOR

(71) Applicant: SUMITOMO MITSUI BANKING CORPORATION, Tokyo (JP)

(72) Inventors: Kiyonori UGAJIN, Tokyo (JP); Kazuya IKEDA, Tokyo (JP); Tomoo YAMADA, Tokyo (JP); Masato HAYASHI, Tokyo (JP); Masato KANO, Tokyo (JP)

(21) Appl. No.: 15/563,244

(22) PCT Filed: Mar. 31, 2015
(86) PCT No.: PCT/JP2015/001866

§ 371 Date: Sep. 29, 2017

(51) Int. Cl. G06Q 40/02

(52) U.S. Cl. CPC G06Q 40/025

(57) ABSTRACT

A credit administration management system includes: a control card storage unit that stores a credit application number, a scheduled signing date, a scheduled credit issuance date, a status, and check completion flags for a plurality of bank rule items in each predetermined term, while associating them with a control card code; and a control card creation unit that registers a record in the control card storage unit in response to reception of the credit application number, a credit application condition part containing a condition for conditionally approving a credit application, and a fulfillment deadline, and a terms and conditions part containing a condition required for lending, the control card creation unit storing a value indicating incompletion in an item to be checked among the plurality of bank rule items based on the credit application condition part and the terms and conditions part.

### TECHNICAL FIELD

The present invention is related to a credit administration management system and a method therefor. More specifically, the present invention is related to a system and a method which achieve improvement of efficiency of an entire series of credit operations and enhancement of an internal management structure by using a control card, which enables visualization of items to be checked by a clerical department in every stage and progress in a procedure of the credit operations.

### BACKGROUND ART

Global companies that operate worldwide by taking advantage of their excellent products and services have been recently increased. Most of the global companies have affiliates or the like in multiple countries. Banks also establish branches and provide financial services worldwide in order to respond to the needs from clients around the world.

In most cases, credit operations of a bank have been done conventionally in a specific branch. Specifically, first, a sales person in a sales department of the specific branch negotiates with a client, and prepares a credit application based on the client negotiation. Next, a clerk in the sales department of the same branch checks the format of the credit application and contents of required documents which the sales representative prepared. Thereafter, a staff in a credit department of a head office makes final decision on the credit application prepared by the sales representative. Then, a clerk in a credit administration department of the same branch as the sales department check whether the terms and conditions are fulfilled, through operations such as comparing the approved credit application and a contract document. Finally, a clerk in an account administration department of the same branch as the sales department and the credit administration department works on administrative processing to issue the lending.

Patent Literature 1 discloses a financing examination system, which comprises: a client information database for centrally managing information on a client who is a target of the financing examination; multiple operation processors that each process one of a series of operations required for the financing examination by using the client information database; and a process status manager that displays a list of statuses of the processes being performed by all the operation processors. The financing examination system described in Patent Literature 1 manages the status of each operation of the financing examination according to a process order in the database, and thus allows bank staffs of a head office and a branch to share the information.

At present, in association with the globalization of companies, credit operations have been changed in process style and are now processed among the branches around the world. For example, there is a case as an example where a company X having a head office in a country A wants to issue financing in a country C in which its local office is located.

In this case, the credit operations of the bank may be conducted as follows. First, a sales person in a sales department in a branch a of the country A negotiates with a client and prepares a credit application. Next, a clerk in the sales department of the branch a checks a content of the credit application. Thereafter, a staff in a credit department of a branch b in a country B makes final decision on the credit application. Then, a clerk in a credit administration department of a branch c in the country C checks the approved credit application and a contract document, and finally, a clerk in an account administration department of the branch c works on administrative processing to issue the lending.

According to Patent Literature 1, the process of preparing the credit application, which is an upstream step of the credit operations, is segmentalized so that the process status thereof can be managed, and the history up to issuing the credit application can be checked by persons such as a sales person, other bank staff of the branch, a branch manager, and a bank staff of the credit department of the head office. Patent Literature 1, however, does not mention an advantage that may be obtained by promoting visualization of the necessity of management and check items in a subsequent step of the credit operations to be accomplished by the credit administration clerk.

In the case where the credit operations are processed among the branches around the world, the operations of the sales department which negotiates with a client, and of the administration department which works on the lending issuance become more complicated than in the case where the credit operations are processed among domestic branches. Thus, the two departments need to collaborate more strongly. Specifically, first of all, the bank needs to comply with bank rules to work on the credit operations. Thus, in the credit operations, it is necessary to completely extract all the items to be checked for the compliance of the bank rules, and to check each of the items by an appropriate department. However, if the involved departments locate in different countries, it is difficult for these departments to collaborate each other. Hence, there have been cases where the bank rule items are redundantly managed and the locus of responsibility is unclear.

Second, in the credit operations, there are not only the bank rule items which should be checked for all the credit operations in common to the world, but also regional regulation items which should be followed in each region in which lending is issued. In the case where the involved departments locate in different countries, it is more difficult for the sales person in the sales department in the country A to completely extract all the regional regulation items of the country C than in the case where the processing is performed among the domestic branches. Hence, the sales person consumes time for a task such as inquiring the regional regulations and complying with them, which declines the efficiency of the operations.

Third, while the bank deals with various information on the clients in the credit operations, the bank must deal with the information with great caution. For example, the sales department, which negotiates with the clients, has authority to browse all of the client information in principle; however, the administration department should have authority to browse the minimal client information for completing the assigned operations. In the case where the involved departments locate indifferent countries, it is more difficult to strictly control the access to the client information than in the case where the processing is performed among the domestic branches. There may be a case where the salesperson in the sales department of the country A carelessly forwards an electronic document with no access control to the clerical department of the country C.

### CITATION LIST

### Patent Literature

PTL 1: Japanese Patent Laid-Open No. 2005-134937

### SUMMARY OF INVENTION

In view of such circumstances, an object of the present invention is to provide a system and a method which achieve improvement of efficiency of entire series of credit operations and enhancement of the internal management structure by using a control card, which enables visualization of items to be checked by an administration department in every stage and progress in a procedure of the credit operations.

A credit administration management system as an aspect of the present invention includes: a control card storage unit that stores a credit application number, a signing schedule date, a credit issuance schedule date, a status, and check completion flags for a plurality of bank rule items in each predetermined term, while associating them with a control card code; and a control card creation unit that registers a record in the control card storage unit in response to reception of the credit application number, a credit application condition part containing a condition for conditionally approving a credit application and a fulfillment deadline, and a terms and conditions part containing a condition required for lending, the control card creation unit storing a value indicating incompletion in each bank rule item to be checked among the plurality of bank rule items based on the credit application condition part and the terms and conditions part.

A method for a credit administration management system as an aspect of the invention in the credit administration management system, which includes a control card storage unit that stores a credit application number, a scheduled signing date, a scheduled credit issuance date, a status, and check completion flags for a plurality of bank rule items in each predetermined term while associating them with a control card code, the method including executing: a step by a control card creation unit of receiving a credit Application condition part containing the credit Application number, a condition for conditionally approving a credit Application, and a fulfillment deadline, as well as a terms and conditions part containing a condition required for lending; and a step by the control card creation unit of registering a record in the control card storage unit based on the received information, and storing a value indicating incompletion in an item to be checked among the plurality of bank rule items based on the credit application condition part and the terms and conditions part.

According to the present invention, using a control card, which enables visualization of items to be checked by a clerical department in every stage and progress, can avoid conventional matters causing operational efficiency declination such as redundantly managing bank rule items, referring to regional regulations, and so on, and can achieve improvement of efficiency of the entire series of credit operations and enhancement of the internal management structure.

Further, according to the present invention, providing the minimal information disclosure depending on the branch and the role of the person in charge involved in the credit operations can strictly control the access to client information.

### BRIEF DESCRIPTION OF DRAWINGS

FIG. 1 shows an exemplified entire network structure according to the present invention;

FIG. 2 shows a system structure of an exemplified credit administration management system according to the present invention;

FIG. 3 is a functional block diagram of the exemplified credit administration management system according to the present invention;

FIG. 4 shows an example of information stored in an exemplified person in charge DB;

FIG. 5 shows an example of information stored in an exemplified credit application DB;

FIG. 6A shows an example of information stored in an exemplified control card DB;

FIG. 6B shows an example of information stored in an exemplified control card DB;

FIG. 6C shows an example of information stored in an exemplified control card DB;

FIG. 6D shows an example of information stored in an exemplified control card DB;

FIG. 6E shows an example of information stored in an exemplified control card DB;

FIG. 7 shows an example of information stored in an exemplified regional regulation DB;

FIG. 8 shows an example of information stored in an exemplified terms and conditions check DB;

FIG. 9 shows an example of information stored in an exemplified collateral/guarantee check DB;

FIG. 10 shows an example of information stored in an exemplified document check DB;

FIG. 11 shows a flowchart of processing of creating a control card;

FIG. 12 shows an example of a screen of the control card displayed on a client computer;

FIG. 13 shows an example of a contract check screen displayed on the client computer; and

FIG. 14 shows an example of a screen of the control card displayed on the client computer.

### DESCRIPTION OF EMBODIMENTS

A credit administration management system and a method therefor according to embodiments of the present invention are described below in detail with reference to the accompanying drawings.

In this specification, out of items to be checked for compliance of bank rules and regional regulations, an item to be checked in common for all the credit transactions around the world is described using a term “bank rule item.”

In this specification, out of the items to be checked for compliance of the bank rules and the regional regulations, an item to be followed in each region in which lending is issued is described using a term “regional regulation item.”

In this specification, a sales department, which negotiates with a client, is described using a term “front,” a credit administration department is described using a term “middle-back,” and an account administration department is described using a term “back.”

In this specification, a group of information, which is able to visualize items what a clerical department should check in every stage and progress thereof, in a procedure of credit operations is described using a term “control card.”

In the following embodiments, a bank 1 having a branch a in a country A, a branch b in a country B, and a branch c in a country C is used as an example for the descriptions.

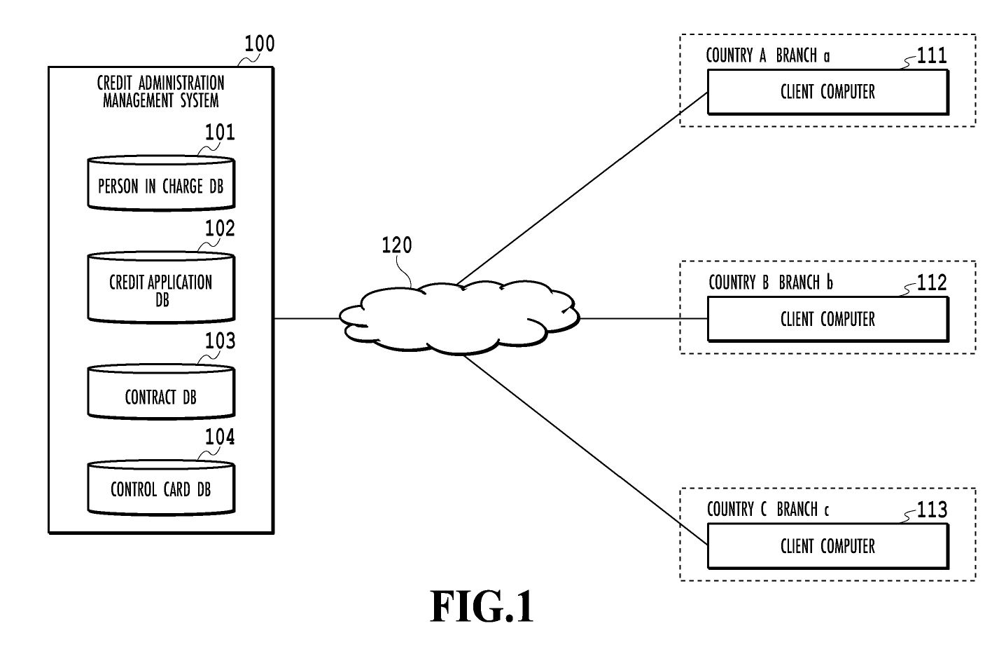

FIG. 1 shows an exemplified entire network structure according to the present invention. In FIG. 1, a credit administration management system 100, a client computer 111 installed in the branch a of the country A, a client computer 112 installed in the branch b of the country B, and a client computer 113 installed in the branch c of the country C are communicatably connected via a bank network or the Internet 120.

The credit administration management system 100 comprises a person in charge database (DB) 101 for storing information on a bank staff of the bank 1, a credit application database (DB) 102 for storing a credit application, a contract database (DB) 103 for storing a contract, and a control card database (DB) 104, and manages the credit operations processed among the branches around the world. When a bank staff of each country accesses to the credit administration management system 100 via the client computer 111 and the like, the credit administration management system 100 controls and discloses the information in the credit application DB 102, the contract DB 103, and the control card DB 104 depending on the belonging branch and the role of the bank staff stored in the person in charge DB 101.

The client computer 111 is a client computer installed in the branch a of the country A. For example, a person in charge of a front of the branch a can access to the credit administration management system 100 via the client computer 111 and store a prepared credit application in the credit application DB 102. The person in charge of the front of the branch a can also access to the credit administration management system 100 via the client computer 111 and store a prepared contract in the contract DB 103.

The client computer 112 is a client computer installed in the branch b of the country B. For example, an examination representative of the branch b can access to the credit administration management system 100 via the client computer 112 and browse the credit application stored in the credit application DB 102.

The client computer 113 is a client computer installed in the branch c of the country C. For example, a person in charge of a middle-back of the branch c can access to the credit administration management system 100 via the client computer 113 and update information in the control card DB 104.

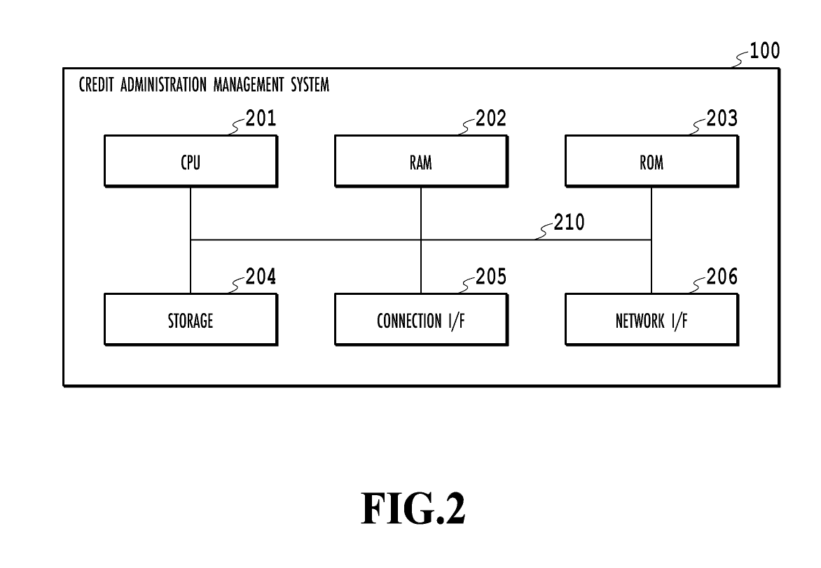

FIG. 2 shows a system structure of the credit administration management system 100. The credit administration management system 100 comprises a CPU 201, a RAM 202, a ROM 203, storage 204, a connection interface 205, and a network interface 206. The components 201 to 206 are communicatably connected to each other via a bus 210.

The CPU 201 controls the device and circuits as well as performs computing and data processing. The RAM 202 is a temporal storage area, which is used when the CPU 201 executes computing. The ROM 203 is a storage area for storing various programs. The storage 204 is composed of, for example, a hard disk drive (HDD), a solid state drive (SSD), and the like, and stores various data. Under the control of the CPU 201, the data is read from the storage 204 and is written into the storage 204.

The connection interface 205 is an interface for connecting various devices to the credit administration management system 100. For example, a display, a keyboard, a mouse, an external storage apparatus, and the like can be connected to the credit administration management system 100 via the connection interface 205.

The network interface 206 is connected to the bank network or the Internet 120 through a communication line. Under the control of the CPU 201, the network interface 206 controls input and output of the data between the bank network or the Internet 120 and the credit administration management system 100. The connection between the network interface 206 and the bank network or the Internet 120 may either be wired or wireless.

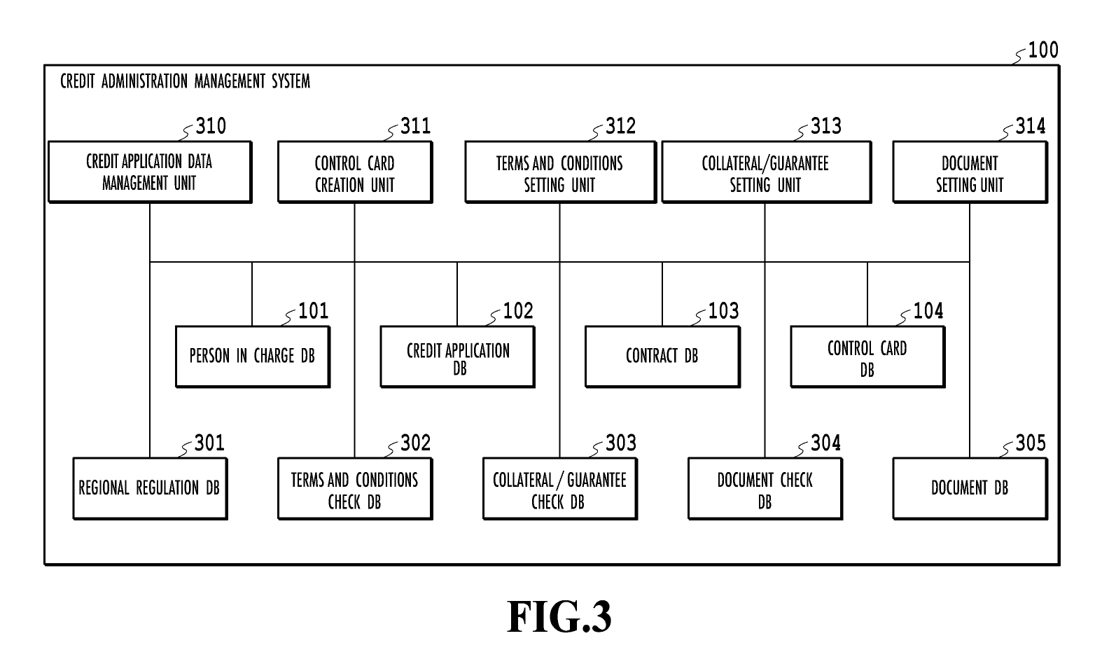

FIG. 3 is a functional block diagram of the credit administration management system 100. The credit administration management system 100 comprises the person in charge DB 101, the credit application DB 102, the contract DB 103, the control card DB 104, a regional regulation DB 301, a terms and conditions check DB 302, a collateral/guarantee check DB 303, a document check DB 304, a document DB 305, a credit application data management unit 310, a control card creation unit 311, a terms and conditions setting unit 312, a collateral/guarantee setting unit 313, and a document setting unit 314.

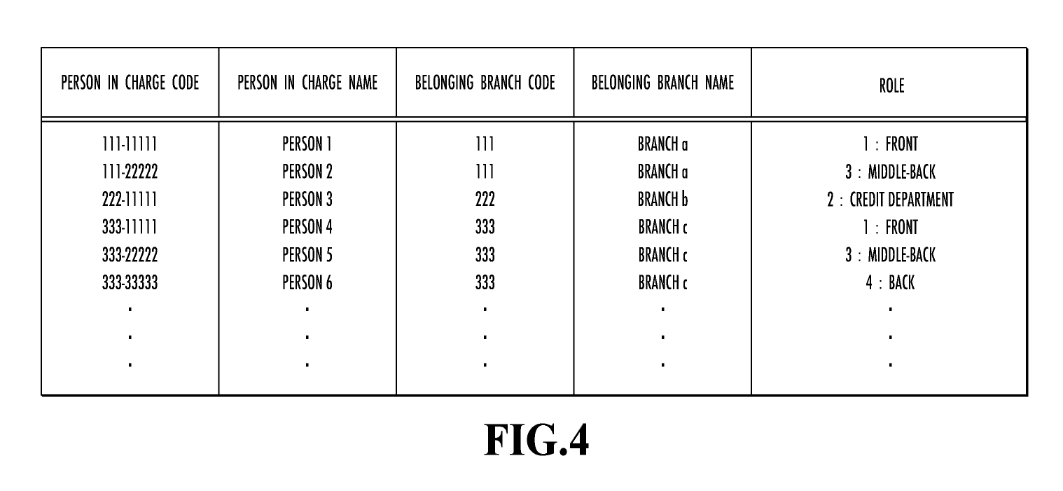

The person in charge DB 101 stores information on a bank staff of the bank 1. In one embodiment, as shown in FIG. 4, the person in charge DB 101 stores a person in charge code, a person in charge name, a belonging branch code, a belonging branch name, and a role (“0: Other,” “1: Front,” “2: Credit Department,” “3: Middle-Back,” or “4: Back”).

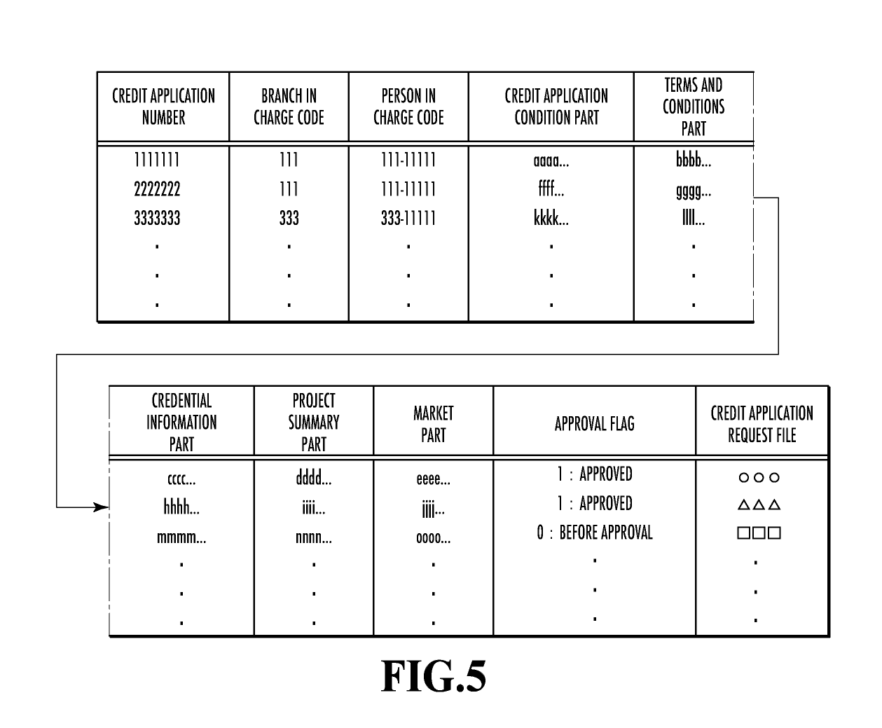

The credit application DB 102 stores the information on the credit application. In one embodiment, as shown in FIG. 5, associating with a credit application number for uniquely identifying the credit application, the credit application DB 102 stores information of the person in charge who prepares the credit application (a branch in charge code and the person in charge code), parts that contain information composing the credit application (a credit application condition part, a terms and conditions part, a credential information part, a project summary part, and a market part), an approval flag (“0: Before Approval,” or “1: Approved”), and an electronic credit application file.

In this embodiment, each part stores a structured document such as XML. Descriptions of each part are given below.

The credit application condition part contains a condition for conditionally approving the credit application, an answer to be described when the condition is fulfilled, and a fulfillment deadline. The terms and conditions part contains conditions required for lending such as loanee information, a type of the credit, a money amount of credit, a credit issuance date, a credit issuance country, and collateral/guarantee. The credential information part contains credential information of the loanee. The project summary part contains history information of the credit transaction. The market part contains market information related to the credit transaction.

Associating with a contract code for uniquely identifying the contract, the contract DB 103 stores the electronic contract file. In another embodiment, the contract DB 103 may not be provided and the electronic contract file can be stored in the later-described document DB 305.

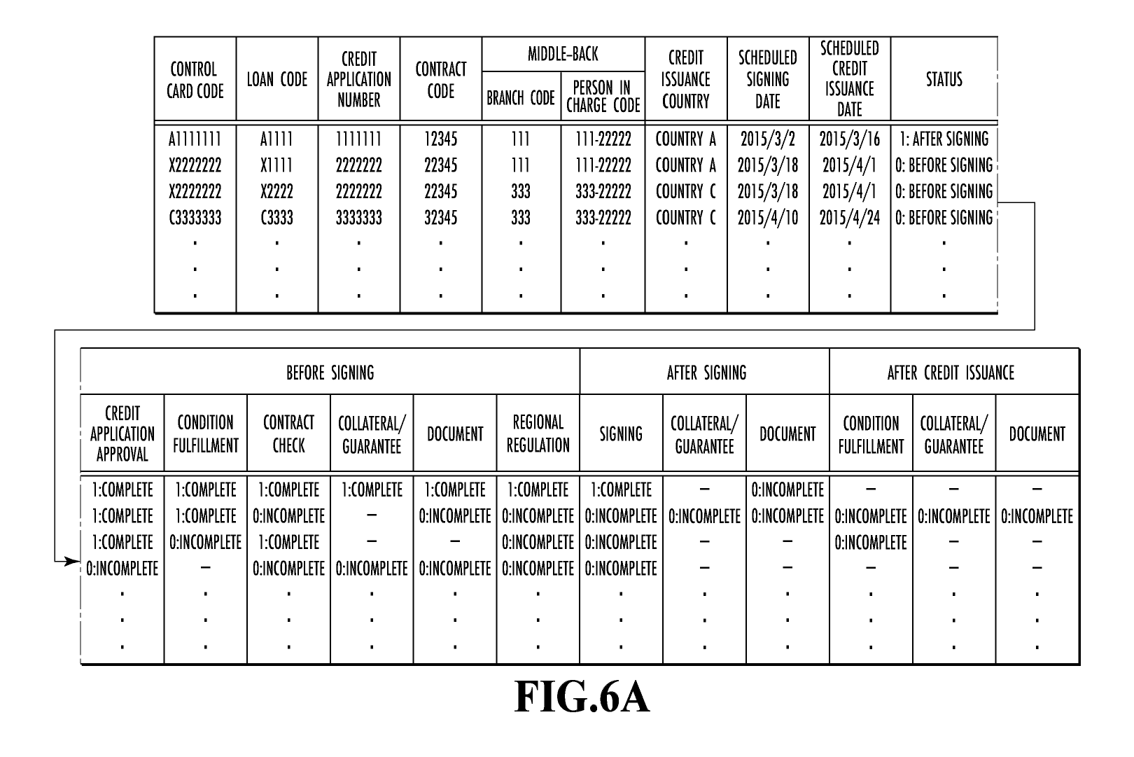

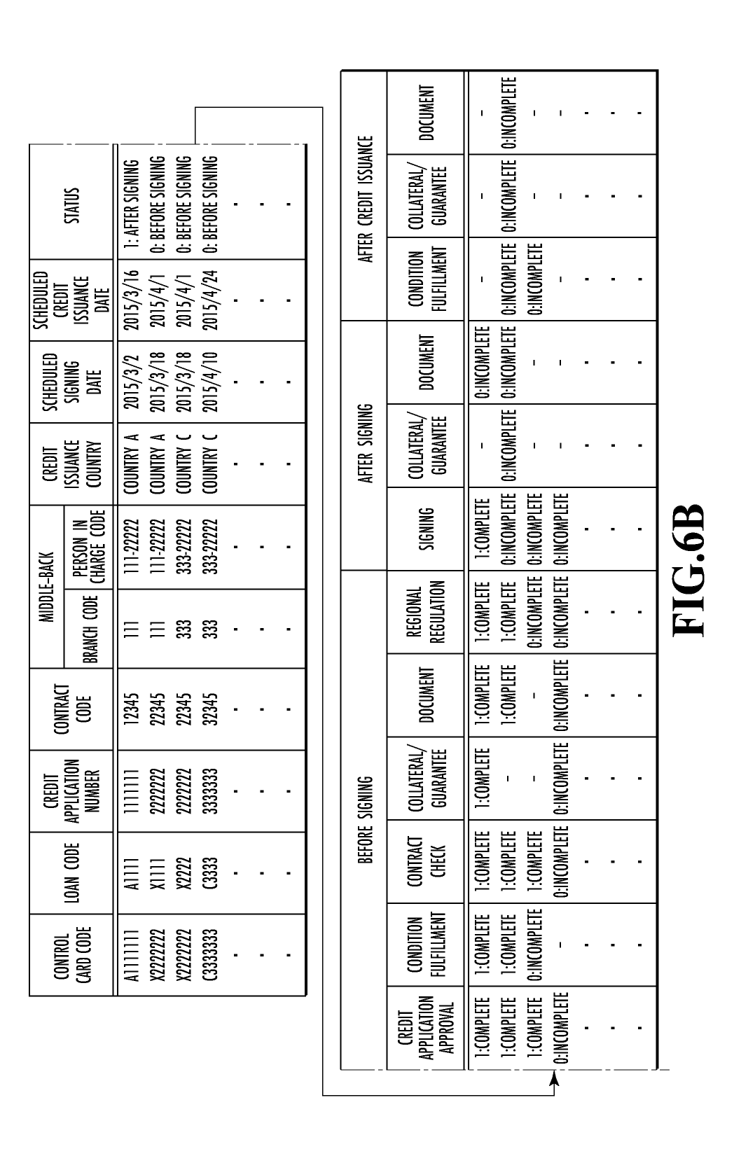

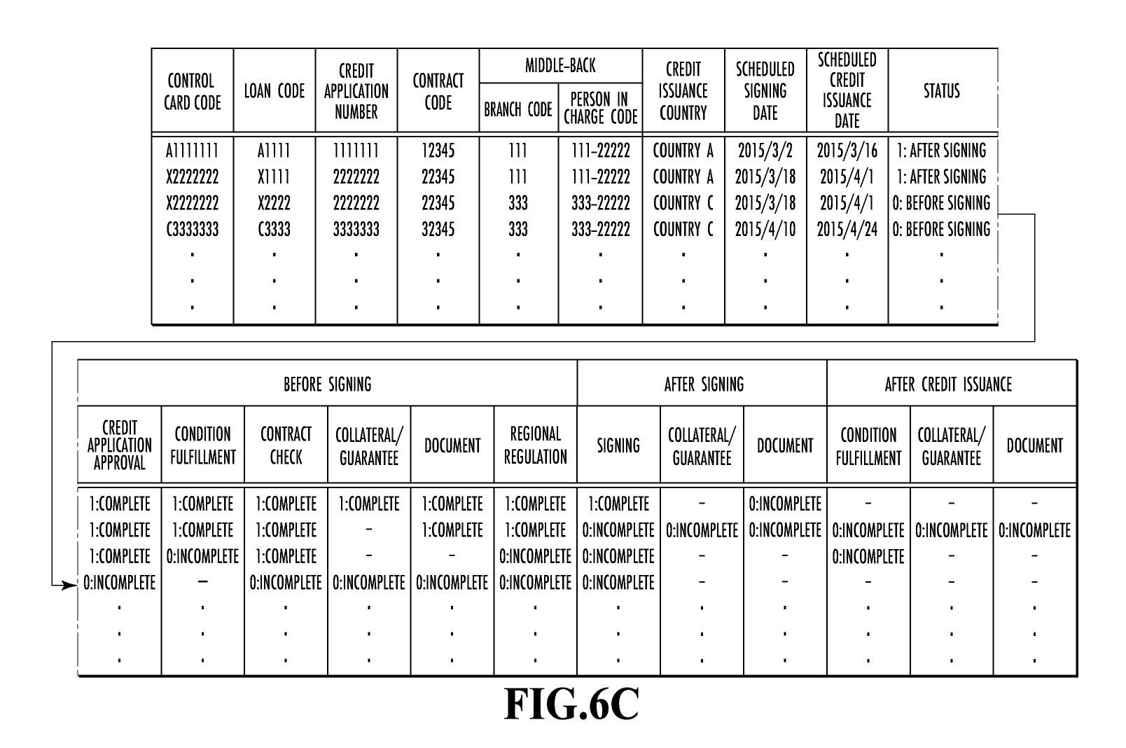

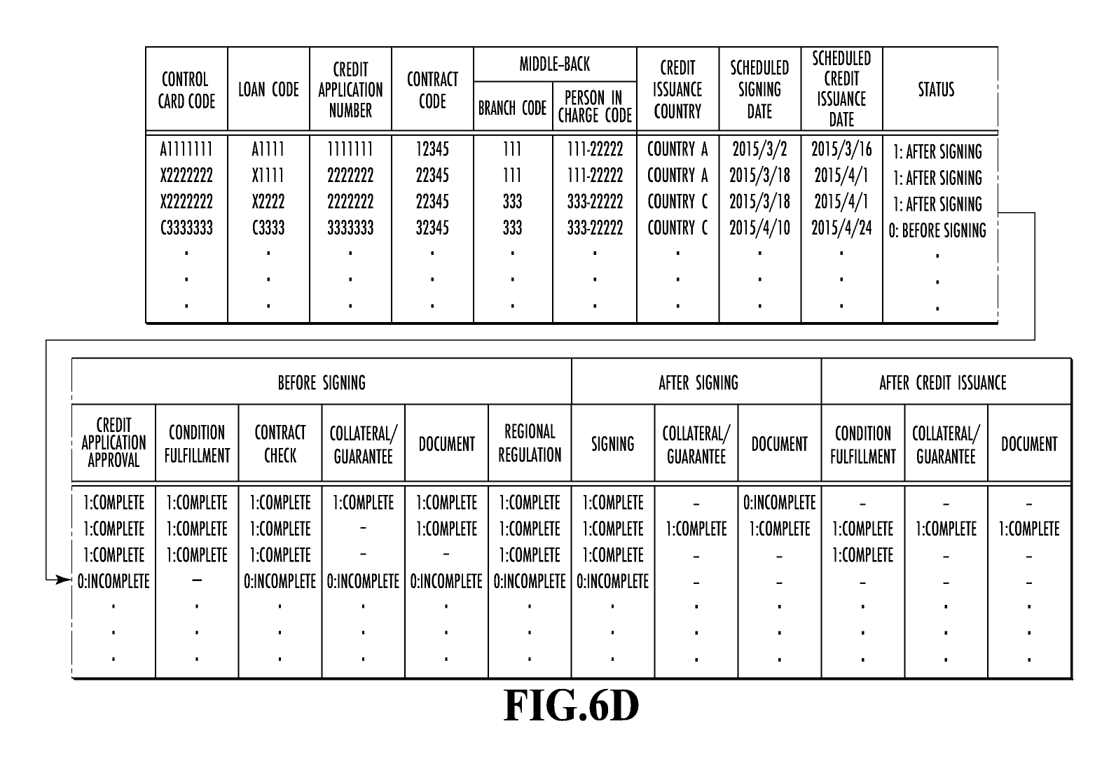

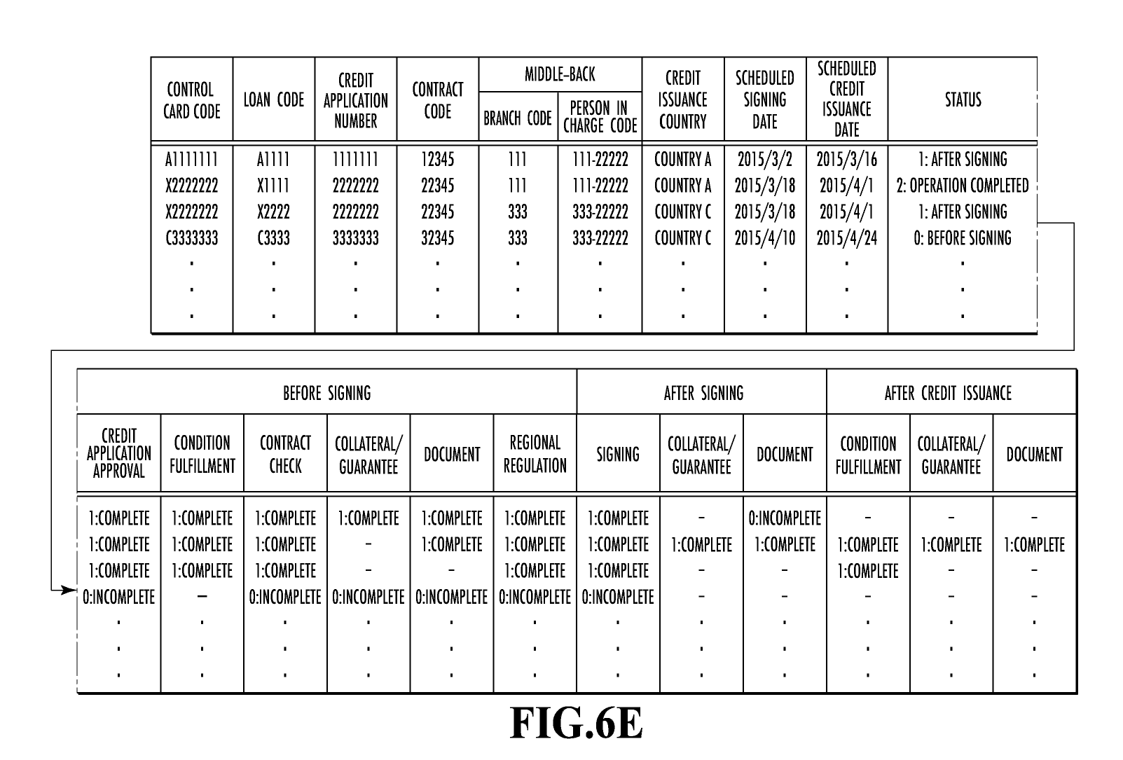

The control card DB 104 stores information associating with a control card. In one embodiment, as shown in FIGS. 6A to 6E, the control card DB 104 stores a control card code, which enables the control card to be uniquely identified, a loan code, the credit application number of the credit application DB 102, the contract code of the contract DB 103, a middle-back branch code, a middle-back person in charge code, the credit issuance country, a scheduled signing date, a scheduled credit issuance date, a status (“0: BEFORE SIGNING,” “1: AFTER SIGNING,” or “2: Operation Complete”), the bank rule items to be checked before signature (CREDIT APPLICATION APPROVAL, CONDITIONS FULFILLMENT, CONTRACT CHECK, COLLATERAL/GUARANTEE, DOCUMENT, and REGIONAL REGULATION), the bank rule items to be checked after signature and before credit issuance (SIGNING, COLLATERAL/GUARANTEE, and DOCUMENT), and the bank rule items to be checked after credit issuance (CONDITIONS FULFILLMENT, COLLATERAL/GUARANTEE, and DOCUMENT).

Each bank rule item stores “0: Incomplete” or “1: Complete.” Descriptions of each bank rule item are given below.

CREDIT APPLICATION APPROVAL identifies whether the credit application is approved by the credit department. In this embodiment, once “1: Approved” is stored in the approval flag of the credit application DB 102, the credit administration management system 100 stores “1: Complete” in CREDIT APPLICATION APPROVAL.

In the case where the credit application is conditionally approved, CONDITIONS FULFILLMENT identifies whether the condition is fulfilled. In this embodiment, depending on the fulfillment deadline contained in the credit application condition part, the credit administration management system 100 sets the credit application condition to either CONDITIONS FULFILLMENT BEFORE SIGNING or CONDITIONS FULFILLMENT AFTER SIGNING. Thereafter, in this embodiment, once the answer is described in the credit application condition part, the credit administration management system 100 stores “1: Complete” in CONDITIONS FULFILLMENT.

CONTRACT CHECK identifies whether confirmation of the consistency of the approved credit application and the contract is completed. In this embodiment, once the consistency of all the terms and conditions except signature information is confirmed in the later-described terms and conditions check DB 302, the credit administration management system 100 stores “1: Complete” in CONTRACT CHECK.

COLLATERAL/GUARANTEE identifies whether collateral/guarantee is fulfilled. In this embodiment, depending on a fulfillment deadline of the collateral/guarantee contained in the terms and conditions part of the credit application, the credit administration management system 100 sets COLLATERAL/GUARANTEE to either the COLLATERAL/GUARANTEE BEFORE SIGNING, COLLATERAL/GUARANTEE AFTER SIGNING, or COLLATERAL/GUARANTEE AFTER CREDIT ISSUANCE. Thereafter, in this embodiment, once the fulfillment of all the collateral/guarantees with a predetermined term (BEFORE SIGNING, AFTER SIGNING, or AFTER CREDIT ISSUANCE) that is set to the fulfillment deadline in the later-described collateral/guarantee check DB 303 is confirmed, the credit administration management system 100 stores “1: Complete” in COLLATERAL/GUARANTEE of the predetermined term.

DOCUMENT identifies whether the document is collected. In this embodiment, depending on a document obtainment deadline set by the document check DB 304, the credit administration management system 100 sets DOCUMENT to any of DOCUMENT BEFORE SIGNING, DOCUMENT AFTER SIGNING, or DOCUMENT AFTER CREDIT ISSUANCE. Thereafter, in this embodiment, once the collection of all the documents with a predetermined term (BEFORE SIGNING, AFTER SIGNING, or AFTER CREDIT ISSUANCE) that is set to the obtainment deadline in the later-described document check DB 304 is confirmed, the credit administration management system 100 stores “1: Complete” in DOCUMENT of the predetermined term.

REGIONAL REGULATION identifies whether the regional regulation items are followed. In this embodiment, upon receiving a compliance confirmation command from the client computer 111 and the like, the credit administration management system 100 stores “1: Complete” in REGIONAL REGULATION.

SIGNING identifies whether a party of the contract signs on the contract. In this embodiment, once all the signatures are confirmed in the later-described terms and conditions check DB 302, the credit administration management system 100 stores “1: Complete” in SIGNING.

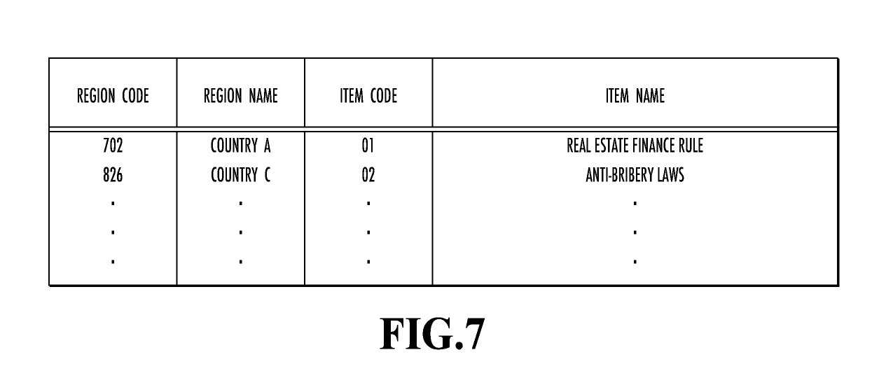

The regional regulation DB 301 stores the regional regulation items. In one embodiment, as shown in FIG. 7, the regional regulation DB 301 stores a region code, a region name, an item code, and an item name.

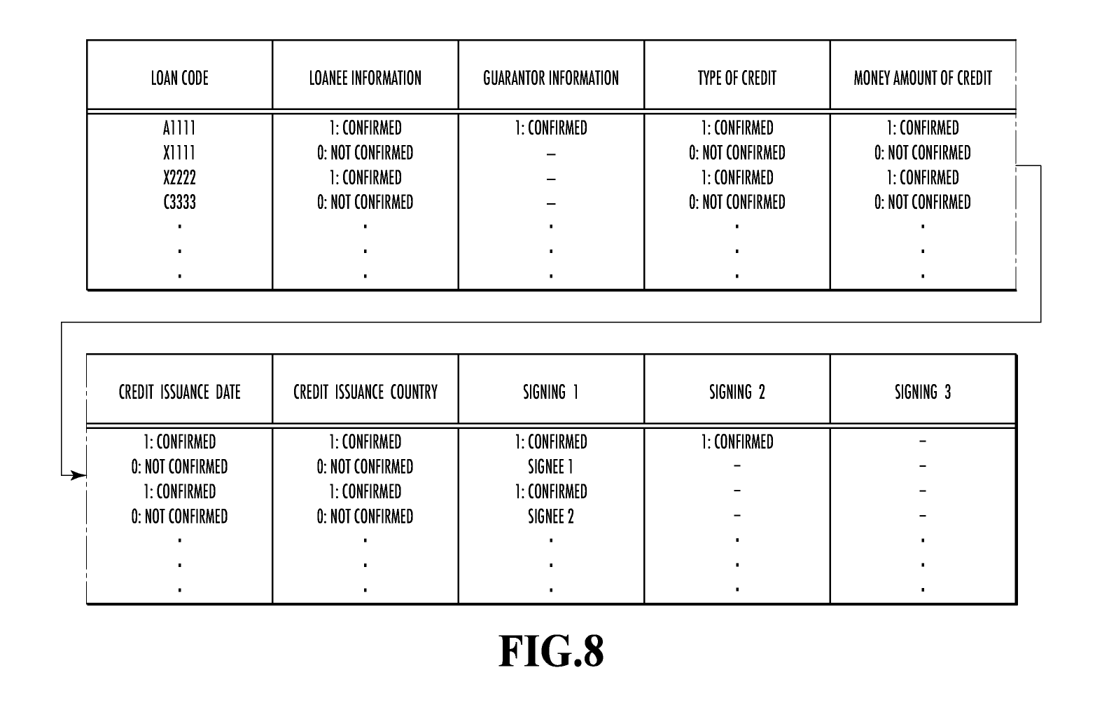

The terms and conditions check DB 302 stores check items set based on the terms and conditions of the credit application. In one embodiment, as shown in FIG. 8, associating with the loan code of the control card DB 104, the terms and conditions check DB 302 stores the loanee information, guarantor information, the type of the credit, the money amount of the credit, the credit issuance date, the credit issuance country, and the signature information. In the signature information, the name of the signee or “1: Confirmed” is stored, and each check item except the signature information stores “0: Not Confirmed” or “1: Confirmed.” In this embodiment, upon receiving a consistency confirmation command from the client computer 111 and the like, the credit administration management system 100 stores “1: Confirmed” in the check item.

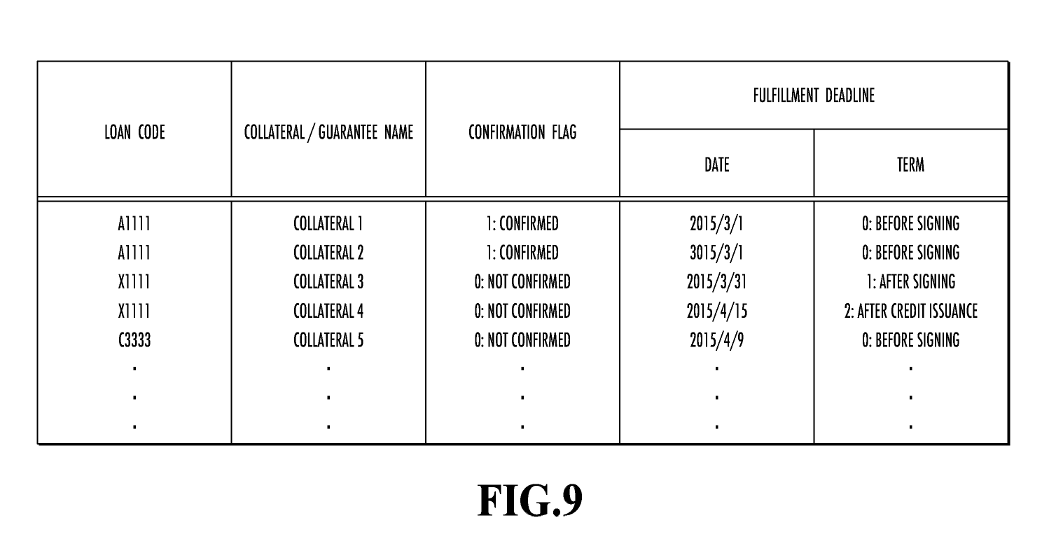

The collateral/guarantee check DB 303 stores collateral/guarantee information included in the terms and conditions of the credit application. In one embodiment, as shown in FIG. 9, associating with the loan code of the control card DB 104, the collateral/guarantee check DB 303 stores a collateral/guarantee name, a confirmation flag (“0: Not Confirmed” or “1: Confirmed”), and a fulfillment deadline. In this embodiment, upon receiving a fulfillment confirmation command from the client computer 111 and the like, the credit administration management system 100 stores “1: Confirmed” in the confirmation flag.

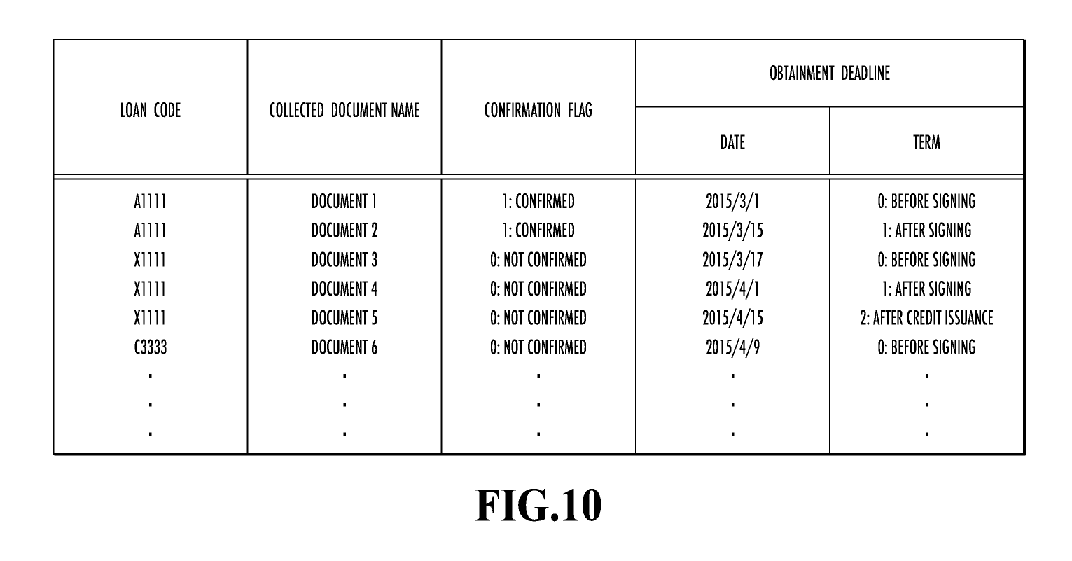

The document check DB 304 stores information of collected document. In one embodiment, as shown in FIG. 10, associating with the loan code of the control card DB 104, the document check DB 304 stores a collected document name, a confirmation flag (“0: Not Confirmed” or “1: Confirmed”), and the obtainment deadline. In this embodiment, upon receiving a document confirmation command from the client computer 111 and the like, the credit administration management system 100 stores “1: Confirmed” in the confirmation flag.

The document DB 305 stores an electronic file. In one embodiment, associating with the loan code of the control card DB 104, the document DB 305 stores an electronic file associating with the credit transaction.

In response to reception of the data associated with the credit application from the client computer 111 and the like, the credit application data management unit 310 registers a record in the credit application DB 102. In this embodiment, the data associated with the credit application includes the branch in charge code of the branch to which the person in charge who prepares the credit application belongs, the person in charge code, the information that is partitioned into parts and composing the credit application, the electronic credit application file prepared from all the information composing the credit application, and designation information of the involved departments in the targeted credit application (the credit department, the middle-back, and the back). The credit application data management unit 310 creates the credit application number, and registers the record in the credit application DB 102 based on the branch in charge code, the person in charge code, the information that partitioned into parts and composing the credit application, and the electronic credit application file, which are included in the data associated with the credit application. At this time, the approval flag is set to “0: Before Approval” as the initial value.

The credit application data management unit 310 also transmits the credit application number, the credit application condition part, the terms and conditions part, and the designation information of the involved departments to the control card creation unit 311.

In response to reception of the credit application number, the credit application condition part, the terms and conditions part, and the designation information of the involved departments from the credit application data management unit 310, the control card creation unit 311 registers a record in the control card DB 104.

Specifically, in this embodiment, with reference to the credit issuance countries contained in the terms and conditions part, the control card creation unit 311 registers a record the number of which corresponding to the number of the credit issuance country. For example, one record is registered when there is one credit issuance country, while two records are registered when there are two credit issuance countries. When the record registration, the control card creation unit 311 generates and stores the control card code corresponding to the credit application number, and the loan code, which enables a plurality of the loans in the same control card code to be uniquely identified.

The control card creation unit 311 stores the received credit application number, the branch code of the middle-back included in the designation information of the involved departments, as well as the credit issuance country contained in the terms and conditions part, the scheduled signing date, and the scheduled credit issuance date. In addition, the control card creation unit 311 can set the person in charge code based on the loanee information contained in the terms and conditions part.

The status is set to “0: BEFORE SIGNING” as the initial value, each of the bank rule items of BEFORE SIGNING, AFTER SIGNING, AFTER CREDIT ISSUANCE except DOCUMENT is set to “0: Incomplete” as the initial value, and DOCUMENT is set to a sign “-” as the initial value. In this specification, the sign “-” means “Not Set.”

Based on the received credit application condition part, the control card creation unit 311 sets CONDITION FULFILLMENT that does not match the fulfillment deadline to the sign (“-”). When the conditions of the CREDIT APPLICATION APPROVAL are not set, the control card creation unit 311 sets all CONDITION FULFILLMENT to the sign (“-”).

Based on the collateral/guarantee contained in the received terms and conditions part, the control card creation unit 311 sets COLLATERAL/GUARANTEE that does not match the fulfillment deadline to the sign (“-”).

Further, based on the credit issuance country contained in the received terms and conditions part, the control card creation unit 311 searches the regional regulation DB 301 for the regional regulation items. When no regional regulation item is found, the control card creation unit 311 sets REGIONAL REGULATION to the sign “-.”

After registering the record in the control card DB 104, in response to reception of the contract preparation data, the control card creation unit 311 sets the contract code in the record of the control card DB 104. In this embodiment, the contract preparation data includes the loan code and the contract code.

Based on the terms and conditions part, the terms and conditions setting unit 312 registers a record in the terms and conditions check DB 302. In this embodiment, associating with the loan code created by the control card creation unit 311, the terms and conditions setting unit 312 registers the record. The terms and conditions setting unit 312 sets the item contained in the terms and conditions part to “0: Not Confirmed,” and sets the item not contained in the terms and conditions part to the sign “-.” In addition, the terms and conditions setting unit 312 sets the signature information (SIGNING 1, SIGNING 2, and SIGNING 3) to the contract party name designated by the terms and conditions part.

Based on the collateral/guarantee contained in the terms and conditions part, the collateral/guarantee setting unit 313 registers a record in the collateral/guarantee check DB 303. In this embodiment, associating with the loan code created by the control card creation unit 311, the collateral/guarantee setting unit 313 registers the record based on collateral/guarantee and the fulfillment deadline contained in the terms and conditions part. At this time, the confirmation flag is set to “0: Not Confirmed” as the initial value.

In this embodiment, when the terms and conditions part contains multiple credit issuance countries, the collateral/guarantee setting unit 313 determines whether different collateral/guarantees are set for each loan to the corresponding credit issuance country. When different collateral/guarantees are set, the collateral/guarantee setting unit 313 registers a record of corresponding collateral/guarantee in each loan code corresponding to the loan to the corresponding credit issuance country.

On the other hand, when the same collateral/guarantee is set, the collateral/guarantee setting unit 313 registers the record of collateral/guarantee in any one of the loan codes. Selecting the loan code can be performed in any way such as prioritizing the loan code assigned to the middle-back of the same branch code as the front, or selecting depending on a size of the branch designated as the middle-back, for example.

In another embodiment, even when the same collateral/guarantee is set, the collateral/guarantee setting unit 313 registers the record of the corresponding collateral/guarantee in each loan code corresponding to the loan to the corresponding credit issuance country. Thereafter, in the later-described collateral/guarantee check screen, a person in charge of any one of the credit issuance countries selects a check column via the client computer 111 and the like in order to respond to the transmission of the fulfillment confirmation command. Then, the credit administration management system 100 stores “1: Confirmed” in the confirmation flag of the collateral/guarantee check DB 303 for all the credit issuance countries that the same collateral/guarantee is set. This enables all the credit issuance countries to share the result registered by the person in charge of any one of the credit issuance countries.

The document setting unit 314 responds to the reception of document list-up data from the client computer 111 and the like, and registers a record in the document check DB 304. In this embodiment, the document list-up data includes the loan code, the collected document name, and the obtainment deadline. Based on the document list-up data, the document setting unit 314 registers the record. At this time, the confirmation flag is set to “0: Not Confirmed” as the initial value.

Based on the document list-up data, the document setting unit 314 also sets DOCUMENT of a control card record, which matches the obtainment deadline, to “0: Incomplete.”

(Control Card Creation Processing)

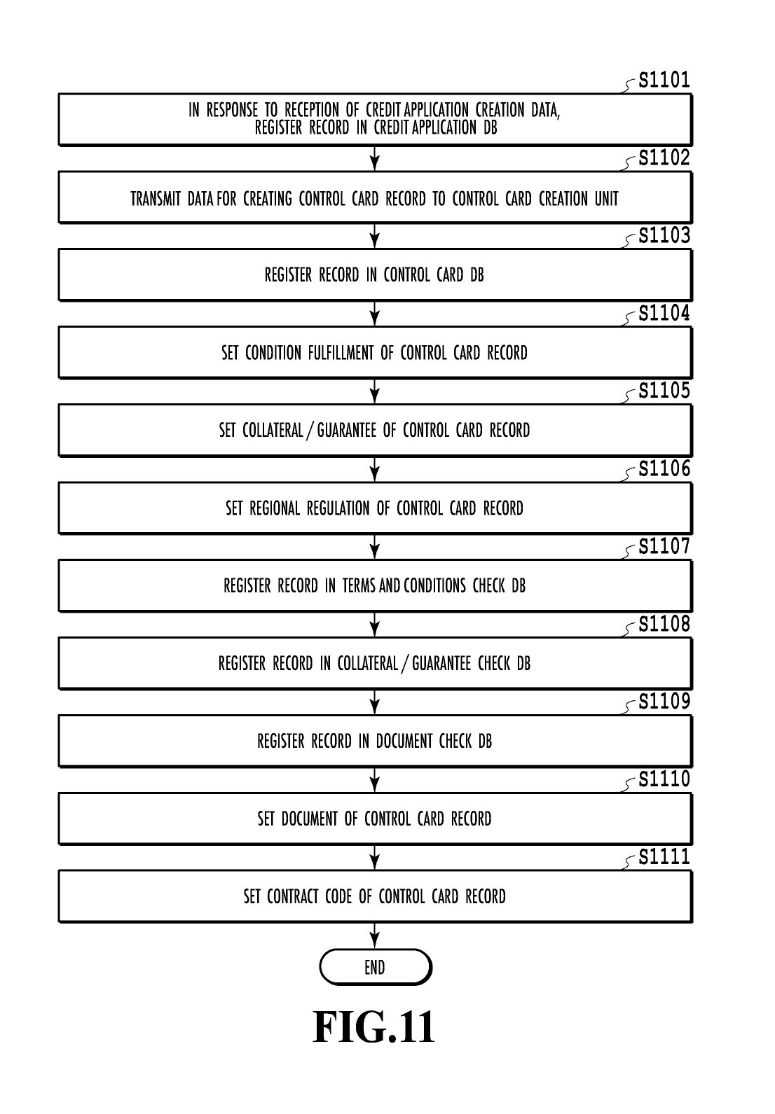

A description of control card creation processing is given with reference to FIG. 11. FIG. 11 shows a flowchart of processing of creating the control card. It is assumed that the person in charge DB 101 of the credit administration management system 100 stores the records shown in FIG. 4. In addition, it is assumed that the regional regulation DB 301 of the credit administration management system 100 stores the records shown in FIG. 7.

The credit application data management unit of the credit administration management system 100 responds to the reception of the data associated with the credit application from the client computer 111 and the like in S1101, and registers the record in the credit application DB 102 in S1102.

In this embodiment, in S1101, upon receiving the data associated with the credit application including the branch in charge code of a branch to which the person in charge who prepares the credit application belongs, the person in charge code, the information that is partitioned into parts and composing the credit application, the electronic credit application file prepared from all the information composing the credit application, and the designation information of the involved departments in the targeted credit application (the credit department, the middle-back, and the back), the credit application data management unit 310 creates the credit application number (3333333) and registers the record in the credit application DB 102. At this time, the approval flag is set to “0: Before Approval” as the initial value.

In S1102, the credit application data management unit 310 transmits the credit application number, the credit application condition part, the terms and conditions part, and the designation information of the involved departments to the control card creation unit 311 of the credit administration management system 100.

In S1103, based on the information received from the credit application data management unit 310, the control card creation unit 311 registers the record in the control card DB 104.

In this embodiment, assuming that the terms and conditions part in which only the country C is designated as the credit issuance country is received, the control card creation unit 311 registers one record based on the received credit application number (3333333), the branch code of the middle-back included in the designation information of the involved departments (333), the credit issuance country contained in the terms and conditions part (country C), the scheduled signing date (2015/4/10), and the scheduled credit issuance date (2015/4/24).

When the record registration, the control card creation unit 311 creates and stores the control card code (C3333333) and the loan code (C3333) corresponding to the credit application number.

In addition, it is assumed that the control card creation unit 311 sets the person in charge code (333-22222) and sets the status to “0: BEFORE SIGNING” as the initial value based on the loanee information contained in the terms and conditions part.

In S1104, based on the received credit application condition part, the control card creation unit 311 sets CONDITION FULFILLMENT that does not match the fulfillment deadline to the sign (“-”).

In this embodiment, assuming that the received credit application condition part is that with no condition of CREDIT APPLICATION APPROVAL is set, the control card creation unit 311 sets FULFILLMENT CONDITION BEFORE SIGNING and FULFILLMENT CONDITION AFTER CREDIT ISSUANCE to the sign (“-”).

In S1105, based on the collateral/guarantee contained in the received terms and conditions part, the control card creation unit 311 sets CONDITION FULFILLMENT that does not match the fulfillment deadline to the sign (“-”).

In this embodiment, assuming that the received terms and conditions part is that with the collateral/guarantee set to the fulfillment deadline before signature (2015/4/9), the control card creation unit 311 sets COLLATERAL/GUARANTEE AFTER SIGNING and AFTER CREDIT ISSUANCE to the sign (“-”).

In S1106, based on the credit issuance country contained in the received terms and conditions part, the control card creation unit 311 searches the regional regulation DB 301 for the regional regulation items. When no regional regulation item is found, the control card creation unit 311 sets REGIONAL REGULATION to the sign “-.”

In this embodiment, it is assumed that the terms and conditions part containing the credit issuance country (country C) is received. The control card creation unit 311 searches the regional regulation DB 301 shown in FIG. 7 for the regional regulations. Since there is a regional regulation item corresponding to the country C, the processing proceeds to the next step.

In S1107, based on the terms and conditions part, the terms and conditions setting unit 312 of the credit administration management system 100 registers the record in the terms and conditions check DB 302.

In this embodiment, it is assumed that, associating with the loan code created by the control card creation unit 311 (C3333), the terms and conditions setting unit 312 registers the record shown in FIG. 8. As shown in FIG. 8, in this embodiment, the terms and conditions part with no guarantor information is received, and the guarantor information is set to the sign “-.” Regarding the signature information (SIGNING 1, SIGNING 2, and SIGNING 3), in this embodiment, assuming that the terms and conditions part only containing Signee 1 is received, the terms and conditions setting unit 312 sets SIGNING 1 to Signee 1, and sets SIGNING 2 and SIGNING 3 to the sign “-.”

In S1108, based on the collateral/guarantee contained in the terms and conditions part, the collateral/guarantee setting unit 313 of the credit administration management system 100 registers the record in the collateral/guarantee check DB 303.

In this embodiment, it is assumed that, associating with the loan code created by the control card creation unit 311 (C3333), the collateral/guarantee setting unit 313 registers the record shown in FIG. 9.

In S1109, in response to reception of the document list-up data from the client computer 111 and the like, the document setting unit 314 of the credit administration management system 100 registers the record in the document check DB 304. Subsequently, in S1110, based on the document list-up data, the document setting unit 314 sets DOCUMENT of the control card record corresponding to the fulfillment deadline to “0: Incomplete.”

In this embodiment, it is assumed that, upon receiving the document list-up data including the loan code (C3333), the collected document name (document 6), and the fulfillment deadline before signature (2015/4/9), the document setting unit 314 registers the record shown in FIG. 10. Subsequently, it is assumed that, based on the document list-up data, the document setting unit 314 sets DOCUMENT BEFORE SIGNING of the control card record to “0: Incomplete”.

In S1111, in response to reception of the contract preparation data, the control card creation unit 311 sets the contract code in the record of the control card DB 104.

In this embodiment, upon receiving the contract preparation data including the loan code (C3333) and the contract code (32345), the control card creation unit 311 sets the contract code of the control card DB 104.

(Control Card Update Processing)

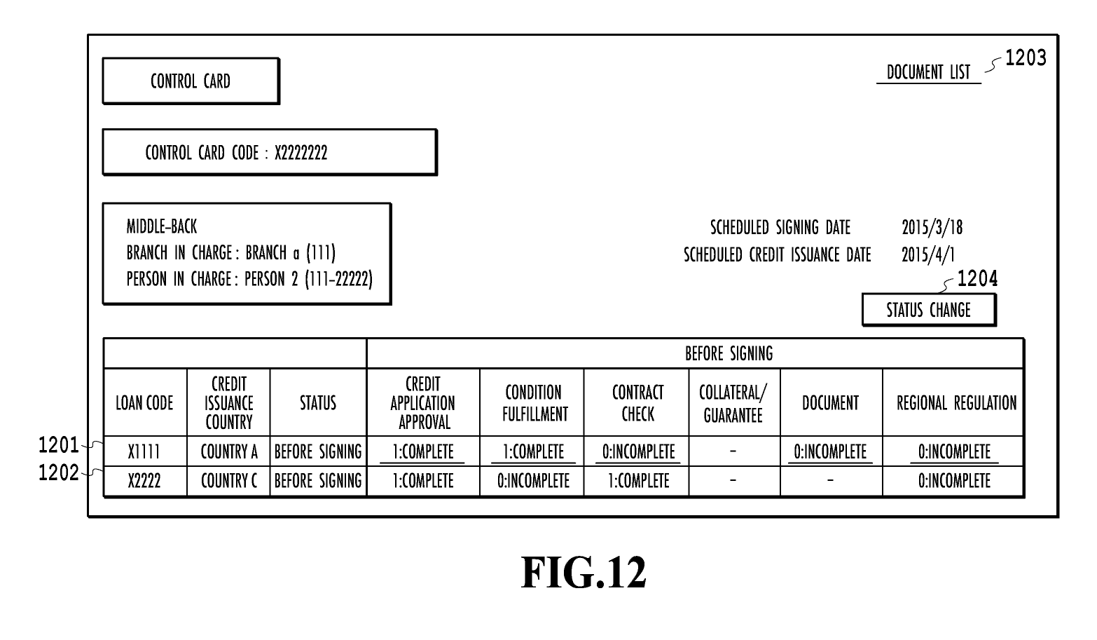

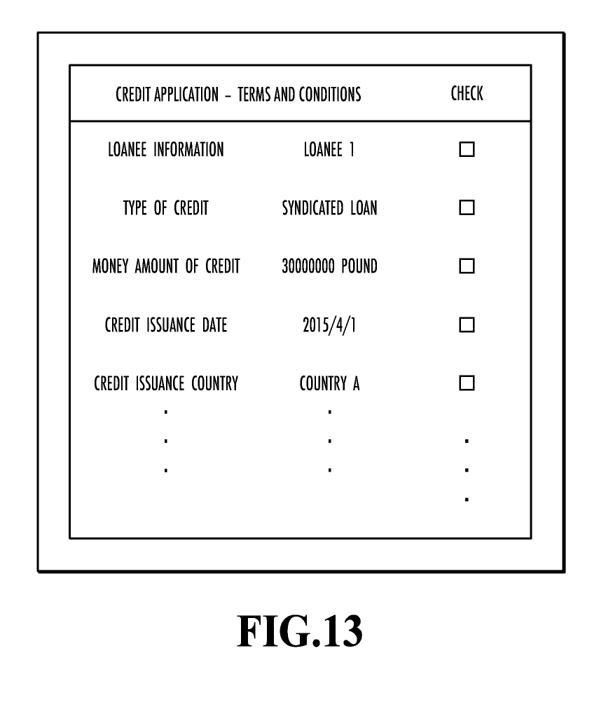

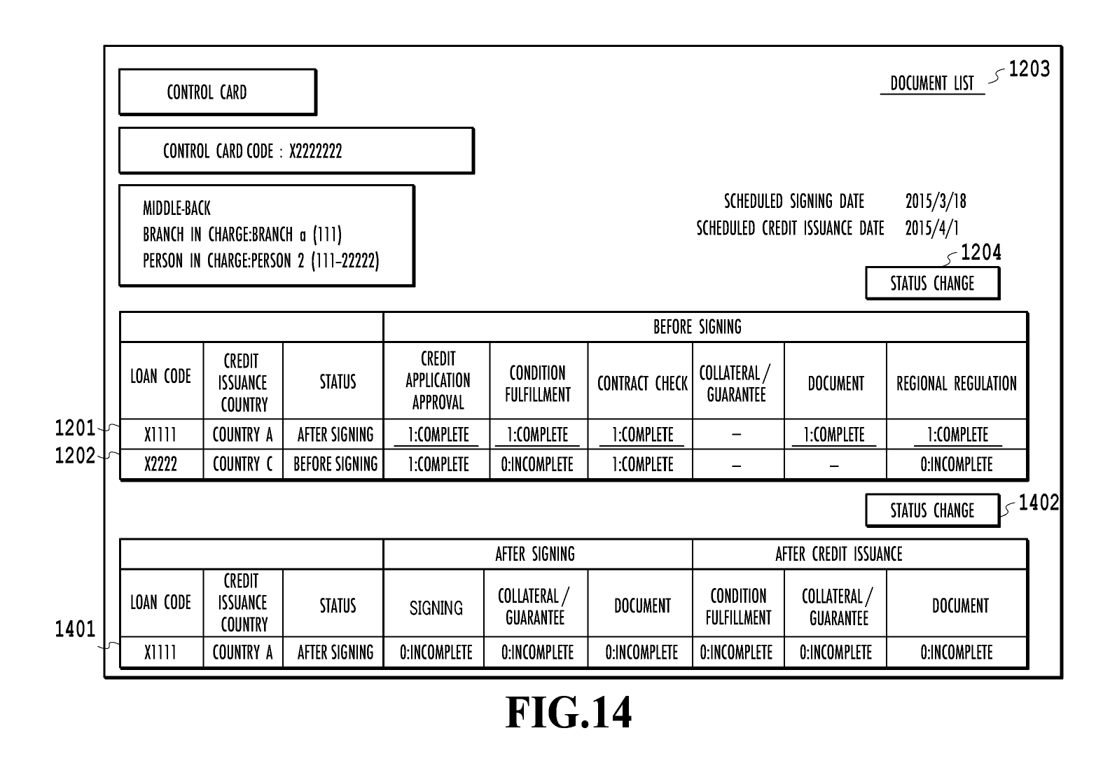

Next, the control card update processing is described with reference to FIGS. 12 to 14. Each of FIGS. 12 and 14 shows an example of a screen of the control card displayed on the client computer. FIG. 13 shows an example of a screen of CONTRACT CHECK displayed on the client computer. It is assumed that the person in charge DB 101, the credit application DB 102, the control card DB 104, the regional regulation DB 301, the contract check DB 302, the collateral/guarantee check DB 303, and the document check DB 304 in the credit administration management system 100 respectively store the records shown in FIGS. 4, 5, 6A, 7, 8, 9, and 10.

In this embodiment, description of processing that PERSON 2 of the branch a of the country A updates the information of the control card identified by the loan code (X1111) via the client computer 111 is given.

It is assumed that PERSON 2 transmits the authentication information including the person in charge code (111-22222), a password, and the like to the credit administration management system 100 via the client computer 111, and the authentication is succeeded based on the authentication information. When the authentication is succeeded, based on the control card DB 104, the credit administration management system 100 can display a list of the control cards assigned to the person in charge who succeeds the authentication.

In this embodiment, it is assumed that the credit administration management system 100 provides the list including two control cards handled by the person in charge who succeeds the authentication (PERSON 2) to the client computer 111, receives a command for selecting a control card identified by the loan code (X1111) from the client computer 111, and provides the screen of the control card shown in FIG. 12 to the client computer 111.

As shown in FIG. 12, when the loan codes are associated with a specific control card code, the screen of the control card displays the information of the loan codes associated with the specific control card code. However, the person in charge can update only the compliance item associated with the loan code handled by that person in charge.

Specifically, although multiple columns 1201 and 1202 specified by the loan code (A1111) and the loan code (X2222), which are associated with the control card code (X2222222), are displayed, PERSON 2 can update only the compliance item of 1201 handled by PERSON 2.

Once a document list 1203 of FIG. 12 is selected, the document list associated with the control card is displayed. In this embodiment, at any timing after the control card record is created, the front person in charge can upload the document while associating with the loan code and can browse the uploaded document from the document list.

Depending on the role of the person in charge who is logging in, the document list selects and displays part or the all of the document associated with the control card. For example, when the front person in charge who prepares the credit application is logging in, the list including all the documents associated with the control card is displayed. In contrast, when PERSON 2 who is the middle-back person in charge is logging in, the list of the document associated with the loan code of 1201 handled by PERSON 2 is selected to be displayed.

Since “1: Approved” is stored in the approval flag of the record identified by the credit application number (2222222) of the credit application DB 102 shown FIG. 5, the credit administration management system 100 already stores “1: Complete” in CREDIT APPLICATION APPROVAL in the column 1201.

In this embodiment, once PERSON 2 selects CREDIT APPLICATION APPROVAL in the column 1201 shown in FIG. 12 (“1: Complete”) via the client computer 111, the credit administration management system 100 can provide a credit application screen (not shown). Depending on the role of the person in charge logging in, the provided credit application screen selects and displays part or the all of the parts composing the credit application. For example, when the front person in charge who prepares the credit application is logging in, a screen including the all parts composing the credit application is displayed. In contrast, when the middle-back person in charge is logging in, only a part needed for the credit clerical operations is selected and displayed.

Based on description of the answer in the credit application condition part, the credit administration management system 100 already stores “1: Complete” in CONDITION FULFILLMENT in the column 1201.

In this embodiment, when PERSON 2 selects CONDITION FULFILLMENT in the column 1201 shown in FIG. 12 via the client computer 111 (“1: Complete”), the credit administration management system 100 can provide a credit application condition screen (not shown). The credit application condition screen includes the information of the credit application condition part.

CONTRACT CHECK in the column 1201 stores “0: Incomplete” as shown in FIG. 12. In this embodiment, when PERSON 2 selects CONTRACT CHECK in the column 1201 shown in FIG. 12 (“0: Incomplete”) via the client computer 111, the credit administration management system 100 can provide a terms and conditions check screen as shown in FIG. 13 based on the terms and conditions check DB 302 shown in FIG. 8.

PERSON 2 confirms the consistency of the contents displayed in Credit Application—Terms and Conditions in the terms and conditions check screen and the contents of the contract. PERSON 2 selects, for example, the document list 1203 of the screen of the control card displayed in FIG. 12 via the client computer 111, and selects the contract from the document list. With such operations, PERSON 2 confirms the consistency by browsing the electronic contract file stored in the contract DB 103.

In this embodiment, once PERSON 2 selects a check column via the client computer 111, and thereby transmitting the consistency confirmation command, the credit administration management system 100 stores “1: Confirmed” in the corresponding check item of the terms and conditions check DB 302. As described above, in this embodiment, in the terms and conditions check DB 302, once the consistency of all the terms and conditions except the signature information is confirmed, the credit administration management system 100 stores “1: Complete” in CONTRACT CHECK of the control card DB 104.

DOCUMENT in the column 1201 stores “0: Incomplete” as shown in FIG. 12. In this embodiment, once PERSON 2 selects DOCUMENT in the column 1201 shown in FIG. 12 (“0: Incomplete”) via the client computer 111, the credit administration management system 100 can provide a document check screen (not shown) based on the document check DB 304 shown in FIG. 10.

In one embodiment, the document check screen includes the collected document name and the check column. The PERSON 2 confirms whether the collected document displayed on the document check screen is surely present in the document list, which is displayed when the document list 1203 of the screen of the control card is selected.

In this embodiment, once PERSON 2 selects the check column via the client computer 111, and thereby transmitting a confirmation command for collected document, the credit administration management system 100 stores “1: Confirmed” in the corresponding check item of the document check DB 304. As described above, in this embodiment, once the collection of all the documents with a predetermined term (BEFORE SIGNING, AFTER SIGNING, or AFTER CREDIT ISSUANCE) that is set to the obtainment deadline in the document check DB 304 is confirmed, the credit administration management system 100 stores “1: Complete” in DOCUMENT of the predetermined term of the control card DB 104.

REGIONAL REGULATION in the column 1201 stores “0: Incomplete” as shown in FIG. 12. In this embodiment, once PERSON 2 selects REGIONAL REGULATION in the column 1201 shown in FIG. 12 (“0: Incomplete”) via the client computer 111, the credit administration management system 100 can provide a regional regulation check screen (not shown).

In one embodiment, the regional regulation check screen includes a name of the regional regulation item and the check column, and PERSON 2 confirms whether the contents of the contract comply with the regional regulation item displayed on the regional regulation check screen.

In this embodiment, once PERSON 2 selects the check column via the client computer 111, and thereby transmitting the compliance confirmation command, the credit administration management system 100 stores “1: Complete” in REGIONAL REGULATION of the control card DB 104.

With the above-described operations, in the control card record identified by the loan code (X1111) in the control card DB 104, all the bank rule items before signature become “1: Complete” as shown in FIG. 6B. Like this, when all the bank rule items before signature become “1: Complete” and PERSON 2 presses down a status change button 1204 on the screen of the control card shown in FIG. 12 via the client computer 111, the status of the control card record identified by the loan code (X1111) is updated from “0: Before signature” to “1: AFTER SIGNING” as shown in FIG. 6C.

In this embodiment, once the status of the control card record is updated from “0: Before signature” to “1: AFTER SIGNING,” the credit administration management system 100 provides the screen of the control card including the bank rule items after signature and after credit issuance to the client computer 111 as shown in FIG. 14.

SIGNING in a column 1401 stores “0: Incomplete” as shown in FIG. 14. In this embodiment, once PERSON 2 selects SIGNING (“0: Incomplete”) in the column 1201 shown in FIG. 14 via the client computer 111, the credit administration system 100 can provide a signature check screen (not shown) based on the terms and conditions check DB 302 shown in FIG. 8.

In one embodiment, the signature check screen includes the signee name and the check column, and PERSON 2 confirms whether any number of signees displayed on the signature check screen apply their signs on the contract. PERSON 2 selects, for example, the document list 1203 of the screen of the control card shown in FIG. 14 or selects the contract from the document list via the client computer 111. With such operations, PERSON 2 confirms the application of the sign by browsing the electronic contract file stored in the contract DB 103.

In this embodiment, once PERSON 2 selects the check column via the client computer 111, and thereby transmitting a signature confirmation command, the credit administration management system 100 stores “1: Confirmed” in the corresponding check item of the terms and conditions check DB 302. As described above, in this embodiment, once all the document names in the terms and conditions check DB 302 are confirmed, the credit administration management system 100 stores “1: Complete” in SIGNING of the control card DB 104.

COLLATERAL/GUARANTEE AFTER SIGNING in the column 1401 stores “0: Incomplete” as shown in FIG. 14. In this embodiment, once PERSON 2 selects COLLATERAL/GUARANTEE AFTER SIGNING in the column 1401 shown in FIG. 14 (“0: Incomplete”) via the client computer 111, the credit administration management system 100 can provide a collateral/guarantee check screen (not shown) based on the collateral/guarantee check DB 303 shown in FIG. 9.

In one embodiment, the collateral/guarantee check screen includes a collateral/guarantee name and the check column, and PERSON 2 confirms whether the collateral/guarantee displayed on the collateral/guarantee check screen is fulfilled.

In this embodiment, once PERSON 2 selects the check column via the client computer 111, and thereby transmitting the fulfillment confirmation command, the credit administration management system 100 stores “1: Confirmed” in the corresponding confirmation flag of the collateral/guarantee check DB 303. As described above, in this embodiment, once the fulfillment of all the collateral/guarantees with a predetermined term (BEFORE SIGNING, AFTER SIGNING, or AFTER CREDIT ISSUANCE) that is set to fulfillment deadline in the collateral/guarantee check DB 303, the credit administration management system 100 stores “1: Complete” in COLLATERAL/GUARANTEE of the predetermined term of the control card DB 104.

Descriptions of DOCUMENT AFTER SIGNING and AFTER CREDIT ISSUANCE, CONDITIONS FULFILLMENT AFTER CREDIT ISSUANCE, COLLATERAL/GUARANTEE AFTER CREDIT ISSUANCE in the column 1401 are omitted since they are duplicated with the descriptions of the already-described bank rule items.

With the above-described operations, in the control card record identified by the loan code (X1111) in the control card DB 104, all the bank rule items become “1: Complete” as shown in FIG. 6D. Like this, when all the bank rule items become “1: Complete” and PERSON 2 presses down a status change button 1402 on the screen of the control card shown in FIG. 14 via the client computer 111, the status of the control card record identified by the loan code (X1111) is updated from “1: AFTER SIGNING” to “2: Operation Complete” as shown in FIG. 6E.

According to the present invention, using the control card, which is able to visualize items what the clerical department should check in every stage and progress thereof, can avoid conventional matters causing operational efficiency declination such as redundantly managing the bank rule items, referring to the regional regulations, and so on, and can achieve improvement of efficiency of the entire series of credit operations and enhancement of the internal management structure.

Further, according to the present invention, providing the minimal information disclosure depending on the branch and the role of the person in charge involved in the credit operations can strictly control the access to the client information.

### Additional Embodiments

In an additional embodiment, the control card DB 104 can further store Product Basis Regulation as the bank rule item.

Depending on a product provided by the bank 1 (a type of the contract), Product Basis Regulation identifies whether the bank rule item to be checked is followed. In this embodiment, once the checks of all the items in the later-described product check DB 306 is confirmed, the credit administration management system 100 stores “1: Complete” in Product Basis Regulation.

The credit administration management system 100 further comprises the product basis check DB 306 and a product basis setting unit 315.

Based on the terms and conditions of the credit application, the product basis check DB 306 stores the information of the item to be checked for the specific product. In one embodiment, associating with the loan code of the control card DB 104, the product basis check DB 306 stores the item name and the confirmation flag (“0: Not Confirmed” or “1: Confirmed”). In this embodiment, upon receiving a confirmation command from the client computer 111 and the like, the credit administration management system 100 stores “1: Confirmed” in the confirmation flag.

Based on the terms and conditions part, the product basis setting unit 315 registers a record in an each product check DB 303. In this embodiment, associating with the loan code created by the control card creation unit 311, the product basis setting unit 313 identifies the item to be checked of the product applicable to the contract, and registers the record. At this time, the confirmation flag is set to “0: Not Confirmed” as the initial value. For example, in the case of a contract on a project that affects the environment, such as oilfield development, the product basis setting unit 315 can set execution of the environmental assessment as the item to be checked of the product applicable to the contract.

Thus, according to the present invention, including the bank rule items, which should be checked depending on the product, in the control card can achieve further improvement of efficiency of the entire series of credit operations and enhancement of the internal management structure.

So far, the principle of the present invention is described with reference to the exemplified embodiments; however, the skilled in the art will understand that various embodiments with changes in structures and details can be implemented without departing from the gist of the present invention. In other words, the present invention can have aspects as a system, apparatus, a method, a program, a storage medium, and the like, for example.

1. A credit administration management system, comprising:
a control card storage unit that stores a Credit Application Number, a signing schedule date, a credit issuance schedule date, a status, and check completion flags for a plurality of bank rule items in each predetermined term, while associating them with a control card code; and
a processing unit; wherein the processing unit being configured to register a record in the control card storage unit in response to reception of the Credit Application Number, a Credit Application condition part containing a condition for conditionally approving a Credit Application and a fulfillment deadline, and a terms and conditions part containing a condition required for lending, the processing unit storing a value indicating incompletion in each bank rule item to be checked among the plurality of bank rule items based on the Credit Application condition part and the terms and conditions part.

2. The credit administration management system according to claim 1, wherein
the control card storage unit further stores one or more loan codes and one or more credit issuance countries, and
the processing unit being configured to register, with reference to the credit issuance countries contained in the terms and conditions part, records the number of which corresponds to the number of the credit issuance countries in the control card storage unit.

3. The credit administration management system according to claim 1 further comprising:
a regional regulation storage unit that stores an item to be followed in each region where lending is issued, wherein
the processing unit being configured to search the regional regulation storage unit based on each of the credit issuance countries contained in the terms and conditions part and set a regional regulation item as one of the plurality of bank rule items.

4. The credit administration management system according to claim 1 further comprising:
a Credit Application storage unit that stores a plurality of parts which contain information composing the Credit Application in association with the Credit Application Number; and
a person in charge storage unit that stores person in charge information including a role, wherein
depending on the role in the person in charge storage unit, the processing unit of the credit administration management system selects and provides part or all of the plurality of parts.

5. The credit administration management system according to claim 1 further comprising:
a terms and conditions check storage unit that stores a check item set based on the terms and conditions of the Credit Application; and
the processing unit being configured to register a record in the terms and conditions check storage unit based on the terms and conditions part, wherein
once all check items set in the terms and conditions check storage unit for confirming consistency of an approved Credit Application and a contract are confirmed consistent, the processing unit of the credit administration management system stores a value indicating completion in the bank rule item concerning the contract check in the control card storage unit.

6. The credit administration management system according to claim 1 further comprising:
a collateral/guarantee check storage unit that stores fulfillment information on collateral/guarantee included in the terms and conditions of the Credit Application; and
the processing unit being configured to register a record in the collateral/guarantee check storage unit based on the terms and conditions part, wherein
once all collateral/guarantees with a predetermined term set to the fulfillment deadline in the collateral/guarantee check storage unit are confirmed fulfilled, the processing unit of the credit administration management system stores a value indicating completion in the bank rule item concerning the collateral/guarantee in the predetermined term in the control card storage unit.

7. The credit administration management system according to claim 1 further comprising:
a document check storage unit that stores information of a secured document; and
the processing unit being configured to register a record in the document check storage unit based on document list-up data including the information of the secured document, wherein
once all documents with a predetermined term set to an obtainment deadline in the document check storage unit are confirmed present, the processing unit of the credit administration management system stores a value indicating completion in the bank rule item concerning the document in the predetermined term in the control card storage unit.

8. The credit administration management system according to claim 1 further comprising:
a product basis check storage unit that stores information of an item to be checked for a specific product; and
the processing unit being configured to register a record in the product basis check storage unit based on the terms and conditions part, wherein
once all items set in the product basis check storage unit are confirmed checked, the processing unit of the credit administration management system stores a value indicating completion in the bank rule item concerning a product basis in the control card storage unit.

9. A method performed by a credit administration management system including a control card storage unit that stores a Credit Application Number, a scheduled signing date, a scheduled credit issuance date, a status, and check completion flags for a plurality of bank rule items in each predetermined term while associating them with a control card code, the method comprising executing:
by a processing unit of the credit administration management system, receiving the Credit Application Number, a Credit Application condition part containing a condition for conditionally approving a Credit Application and a fulfillment deadline, and a terms and conditions part containing a condition required for lending; and
by the processing unit of the credit administration management system, registering a record in the control card storage unit based on the received information, and storing a value indicating incompletion in an item to be checked among the plurality of bank rule items based on the Credit Application condition part and the terms and conditions part.

10. The method according to claim 9, wherein
the control card storage unit further stores one or more loan codes and one or more credit issuance countries, and
the registering includes referring to the credit issuance country contained in the terms and conditions part, and registering records the number of which corresponds to the number of the credit issuance countries in the control card storage unit.

11. The method according to claim 9, wherein
the credit administration management system further includes a regional regulation storage unit that stores an item to be followed in each region where lending is issued, and
the registering further includes:
searching the regional regulation storage unit based on each of the credit issuance countries contained in the terms and conditions part; and
setting a regional regulation item as one of the plurality of bank rule items.

12. The method according to claim 9, wherein
the credit administration management system further includes
a Credit Application storage unit that stores a plurality of parts which contain information composing the Credit Application in association with the Credit Application Number and
a person in charge storage unit that stores person in charge information including a role, and
the method further includes executing, by the processing unit of the credit administration management system, selecting and providing part or all of the plurality of parts depending on the role in the person in charge storage unit.

13. The method according to claim 9, wherein
the credit administration management system further includes a terms and conditions check storage unit that stores a check item set based on the terms and conditions of the Credit Application, and
the method further includes executing:
by the processing unit of the credit administration management system, registering a record in the terms and conditions check storage unit based on the terms and conditions part and
once all check items for confirming consistency of an approved Credit Application and a contract set in the terms and conditions check storage unit are confirmed consistent, by the processing unit of the credit administration management system, storing a value indicating completion in the bank rule item concerning the contract check in the control card storage unit.

14. The method according to claim 9, wherein
the credit administration management system further includes a collateral/guarantee check storage unit that stores fulfillment information of collateral/guarantee included in the terms and conditions of the Credit Application, and
the method further includes executing:
by the processing unit of the credit administration management system, registering a record in the collateral/guarantee check storage unit based on the terms and conditions part; and
once all collateral/guarantees with a predetermined term set to the fulfillment deadline in the collateral/guarantee check storage unit are confirmed fulfilled, by the processing unit of the credit administration management system, storing a value indicating completion in the bank rule item concerning the collateral/guarantee of the predetermined term in the control card storage unit.

15. The method according to claim 9, wherein:
the credit administration management system further includes a document check storage unit that stores information of a secured document; and
the method further includes executing:
by the processing unit of the credit administration management system, registering a record in the document check storage unit based on document list-up data including the information of the secured document; and
once all documents with a predetermined term set to an obtainment deadline in the document check storage unit is confirmed present, by the processing unit of the credit administration management system, storing a value indicating completion in the bank rule item concerning the document of the predetermined term in the control card storage unit.

16. The method according to claim 9, wherein
the credit administration management system further includes a product basis check storage unit that stores information of an item to be checked for a specific product, and
the method further includes executing:
by the processing unit of the credit administration management system, registering a record in the product basis check storage unit based on the terms and conditions part; and
once all items set in the product basis check storage unit are confirmed checked, by the processing unit of the credit administration management system, storing a value indicating completion in the bank rule item concerning a product basis in the control card storage unit.
